(19) United States
(12) Patent Application Publication
(10) Pub. No.: US 2007/0058868 A1
(43) Pub. Date: Mar. 15, 2007

(54) Character reader, character reading method, and character reading program

(75) Inventors: Kazushi Seino, Tokyo (JP); Masanori Terazaki, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignees: KABUSHIKI KAISHA TOSHIBA; TOSHIBA SOLUTIONS CORPORATION

(21) Appl. No.: 11/503,211

(22) Filed: Aug. 14, 2006

(30) Foreign Application Priority Data
Sep. 14, 2005 (JP) P2005-267006

(51) Int. Cl. G06K 9/00; G09G 5/00; G06K 9/22

(52) U.S. Cl. 382/187; 345/179; 382/314

(57) ABSTRACT

A character reader 1 includes: a handwriting information obtaining part that obtains handwriting information of a character which is handwritten on a sheet 4 with a digital pen 2; a character image generating part that generates partial character images in order in which the character is written, based on the obtained handwriting information of the character; and a stroke order display part that displays the generated partial character images in sequence at predetermined time intervals.

### CROSS-REFERENCE TO RELATED APPLICATIONS

This application is based upon and claims the benefit of priority from the prior Japanese Patent Application No. 2005-267006, filed on Sep. 14, 2005; the entire contents of which are incorporated herein by reference.

### BACKGROUND

1. Field of the Invention

The present invention relates to a character reader, a character reading method, and a character reading program for enabling confirmation and correction of a read character by displaying the character on a screen when the character is written on a sheet with, for example, a digital pen or the like.

2. Description of the Related Art

There has been provided a character reader that reads a sheet bearing a handwritten character, for example, a questionnaire sheet or the like as image data by an optical character reader (hereinafter, referred to as an image scanner), performs character recognition processing on the image data, displays a character recognition result and the image data on a screen of a display, and stores the character recognition result after it is confirmed whether or not the character recognition result needs correction.

In the case of this character reader, if a character obtained as the character recognition result needs correction, an operator looks at an image field displayed on a correction window to key-input a character for correction.

However, due to resolution limitation (field image reduction limitation) of the correction window, and the like, the operator cannot visually determine some character unless he/she has the sheet originally read (hereinafter, referred to as an original sheet) at hand.

If the original sheet is in, for example, a remote place, the operator makes a telephone or facsimile inquiry to the other party in the remote place about the character entered in the original sheet and corrects the recognition result obtained by the character reader.

However, this forcibly burdens the operator with a troublesome work of the communication with a person in the remote place and thus increases the work time.

On the other hand, in recent years, there has been developed an art in which instead of an image scanner or the like, a pen-type optical input device called a digital pen or the like is used not only to write a character on a sheet but also to obtain handwriting information, thereby directly generating image data of the written character (see, for example, Patent Document 1).

According to this art, when a person enters a character on a sheet with the digital pen, the digital pen optically reads marks in a unique coded pattern printed on the sheet to obtain position coordinates on the sheet and time information, whereby the image data of the character can be generated.

[Patent Document 1] Japanese Translation of PCT Publication No. 2003-511761

### SUMMARY

The above-described prior art is an art to only read the coordinates of a pointed position on the sheet together with the time and convert a written character into image data, and does not disclose a concrete art for utilizing the obtained information.

The present invention was made in order to solve such a problem, and it is an object thereof to provide a character reader, a character reading method, and a character reading program that enables an operator to surely recognize a character handwritten on a sheet on a correction window and to efficiently perform a confirmation work or a correction work of a character recognition result.

A character reader according to an embodiment of the present invention includes: a handwriting information obtaining part that obtains handwriting information of a character handwritten on a sheet; a character image generating part that generates partial character images in order in which the character is written, based on the handwriting information of the character obtained by the handwriting information obtaining part; and a stroke order display part that displays the partial character images generated by the character image generating part, in sequence at predetermined time intervals.

A character reading method according to an embodiment of the present invention is a character reading method for a character reader including a display, the method comprising: obtaining, by the character reader, handwriting information of a character handwritten on a sheet; generating, by the character reader, partial character images in order in which the character is written, based on the obtained handwriting information of the character; and displaying, by the character reader, the generated partial character images on the display in sequence at predetermined time intervals.

A character reading program according to an embodiment of the present invention is a character reading program causing a character reader to execute processing, the program comprising program codes for causing the character reader to function as: a handwriting information obtaining part that obtains handwriting information of a character handwritten on a sheet; a character image generating part that generates partial character images in order in which the character is written, based on the handwriting information of the character obtained by the handwriting information obtaining part; and a stroke order display part that displays the partial character images generated by the character image generating part, in sequence at predetermined time intervals.

### BRIEF DESCRIPTION OF THE DRAWINGS

FIG. 1 is a block diagram showing the configuration of a character reading system according to an embodiment of the present invention.

FIG. 2 is a view showing the structure of a digital pen of the character reading system in FIG. 1.

FIG. 3 is a view showing an example of a dot pattern on a sheet on which characters are to be entered with the digital pen.

FIG. 4 is a view showing a questionnaire sheet as an example of the sheet.

FIG. 5 is a view showing a questionnaire sheet correction window.

FIG. 6 is a flowchart showing the operation of the character reading system.

FIG. 7 is a flowchart showing stroke order display processing.

FIG. 8 is a view showing a display example where the stroke order of a character image corresponding to a recognition result “?” is shown in a time-resolved photographic manner.

FIG. 9 is a view showing a display example where the stroke order of a character image corresponding to a recognition result “9” is shown in a time-resolved photographic manner.

FIG. 10 is a view showing an example of a reject correction window.

### DETAILED DESCRIPTION

(Description of Embodiment)

Hereinafter, an embodiment of the present invention will be described in detail with reference to the drawings.

It is to be understood that the drawings are provided only for an illustrative purpose and in noway limit the present invention, though referred to in describing the embodiment of the present invention.

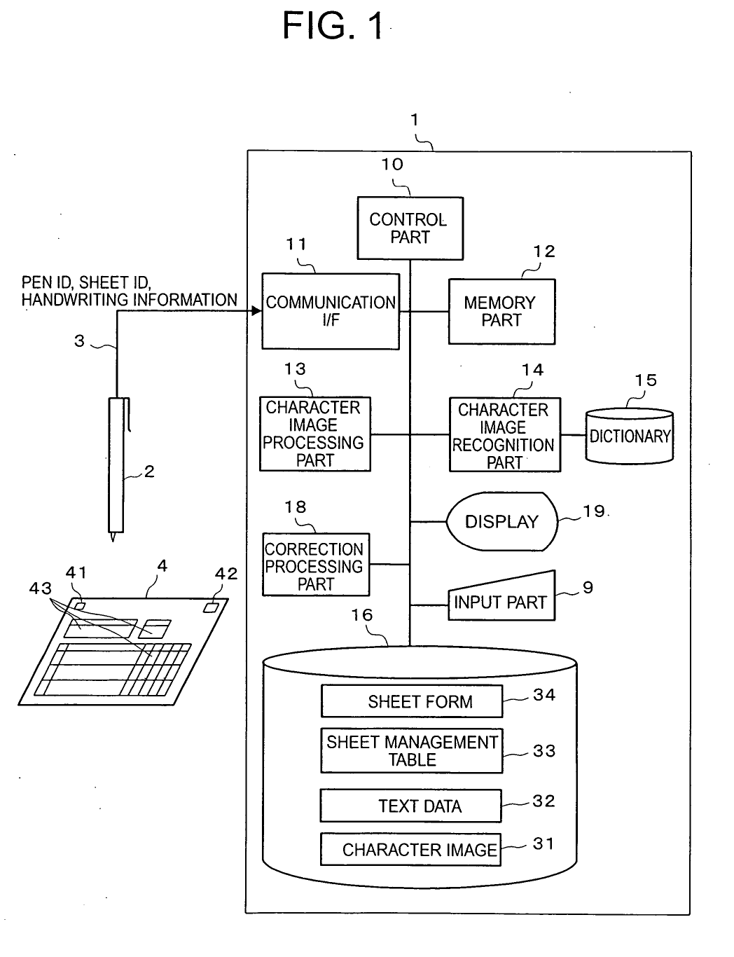

As shown in FIG. 1, a character reading system of this embodiment includes: a digital pen 2 which is a pen-type optical data input device provided with a function of simultaneously performing writing to a sheet 4 and acquisition of handwriting information; and a character reader 1 connected to the digital pen 2 via a USB cable 3.

On an entire front surface of the sheet 4, a dot pattern consisting of a plurality of dots (black points) in a unique arrangement form is printed in pale black.

The dots in the dot pattern are arranged in matrix at intervals of about 0.3 mm.

Each of the dots is arranged at a position slightly deviated longitudinally and laterally from each intersection of the matrix (see FIG. 3).

On the sheet 4, a start mark 41, an end mark 42, and character entry columns 43 are further printed in pale blue.

A processing target of the digital pen 2 is only the dot pattern printed on the front surface of the sheet 4, and the pale blue portions are excluded from the processing target of the digital pen 2.

The character reader 1 includes an input part 9, a control part 10, a communication I/F 11, a memory part 12, a character image processing part 13, a character recognition part 14, a dictionary 15, a database 16, a correction processing part 18, a display 19, and so on, and is realized by, for example, a computer or the like.

Functions of the memory part 12, the character image processing part 13, the character recognition part 14, the correction processing part 18, the control part 10, and so on are realized by hardware such as a CPU, a memory, and a hard disk device cooperating with an operating system (hereinafter, referred to as OS) and a program such as character reading software which are installed in the hard disk device. The CPU stands for central processing unit.

The input part 9 includes an input device such as a keyboard and a mouse and an interface thereof.

The input part 9 is used for key input of text data when the correction processing part 18 executes character correction processing of a recognition result.

The input part 9 accepts key input of new text data for correcting text data displayed on a questionnaire sheet correction window.

The dictionary 15 is stored in the hard disk device or the like. The database 16 is constructed in the hard disk device. The memory part 12 is realized by the memory or the hard disk device.

The character image processing part 13, the character recognition part 14, the correction processing part 18, and so on are realized by the character reading software, the CPU, the memory, and the like.

The display 19 is realized by a display device such as a monitor.

The communication I/F 11 receives, via the USB cable 3, information transmitted from the digital pen 2.

The communication I/F 11 obtains, from the digital pen 2, handwriting information of a character written in each of the character entry columns 43 of the sheet 4.

That is, the communication I/F 11 and the digital pen 2 function as a handwriting information obtaining part that obtains the handwriting information of a character handwritten on the sheet 4.

The memory part 12 stores the handwriting information received by the communication I/F 11 from the digital pen 2. A concrete example of hardware realizing the memory part 12 is the memory or the like.

The handwriting information includes stroke information such as a trajectory, stroke order, speed, and the like of a pen tip of the digital pen 2, and information such as write pressure, write time, and so on.

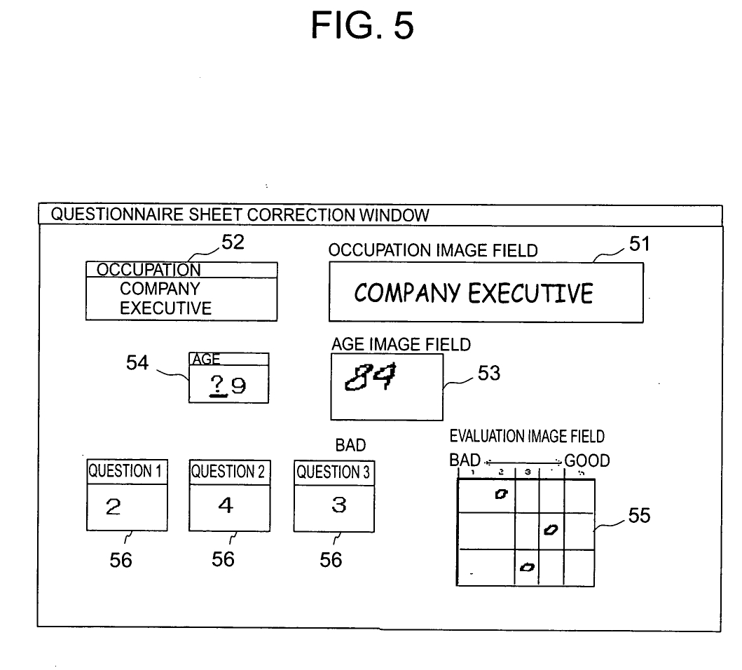

Besides, the memory part 12 also functions as a work area for the following works: storage of a character image that is generated by the character image processing part 13, the character recognition part 14, and the control part 10 based on the handwriting information; character recognition processing by the character recognition part 14; processing by the character image processing part 13 to segment image fields corresponding to a sheet form; processing by the correction processing part 18 to display a window (questionnaire sheet correction window in FIG. 5 in this example) for confirmation or correction work which displays, on the same window, segmented character images and text data being character recognition results; and so on.

Under the control by the control part 10, the character image processing part 13 generates a character image of each character based on the stroke information (trajectory (position data), stroke order, speed, and so on of the pen tip) included in the handwriting information stored in the memory part 12 and coordinate information of a sheet image stored in the database 16, and stores the character image in the memory part 12.

A set of position data (X coordinates and Y coordinates) that indicate traces of the digital pen 2 on the front surface of the sheet 4 during write pressure detection periods is called trajectories, and position data classified into the same pressure detection period, out of the position data (X coordinates, Y coordinates) is called stroke order.

To each of the position data (X coordinates, Y coordinates), the time at which the position is pointed is linked and thus the order in which the position (coordinates) on the sheet 4 pointed by the pen tip shifts and the time passage are known, so that the speed is obtainable from these pieces of information.

The character image processing part 13 functions as a character image generating part that generates image data of each character by smoothly connecting, on the coordinates, dot data of the character based on the handwriting information (position data (X coordinates, Y coordinates) and the time)).

The character image processing part 13 functions as a stroke order display part that displays the order in which a character corresponding to character image data displayed on the display 19 is written, based on the-handwriting information on the character obtained from the digital pen 2 via the communication I/F 11.

At this time, what serves as a trigger for the stroke order display is an instruction operation for displaying the stroke order, for example, an operation such as double-clicking a mouse after moving a cursor onto a relevant image field.

In response to such an instruction operation for the stroke order display, the character image processing part 13 performs image generation processing for displaying the stroke order.

In the image generation processing at this time, image data in a relevant image field on the questionnaire sheet correction window is once erased, partial images in the course until the target image data is completed as one character are sequentially generated, and the partial images are displayed in the relevant image field on the questionnaire sheet correction window.

That is, the character image processing part 13 functions as the stroke order display part that, in response to the operation for displaying the stroke order of the character image data displayed on the display 19, sequentially displays the partial images generated in the course until the target image data is completed as one character, based on the handwriting information of the character obtained from the digital pen 2 via the communication I/F 11.

In the dictionary 15, a large number of character images and character codes (text data) corresponding to the respective character images are stored.

By referring to the dictionary 15, the character recognition part 14 executes character recognition processing for a character image generated by the character image processing part 13 and stored in the memory part 12 and obtains text data as the character recognition result.

The character recognition part 14 assigns text data (character code) such as “?” to a character unrecognizable at the time of the character recognition and this text data is defined as the character recognition result.

The character recognition part 14 stores, in the database 16, character image s31 read from the sheet and text data 32 recognized from the character images 31.

Specifically, the character recognition part 14 collates the character image data generated by the character image processing part 13 with the character images in the dictionary 15 to output the text data.

In the database 16, the character images 31 read from the sheet and the text data 32 as the character recognition results obtained from the character images 31 by the character recognition are stored in correspondence to each other.

Sheet forms 34 are stored in the database 16. Each of the sheet forms 34 is information indicating a form (format) of a sheet having no character entered thereon yet.

The sheet form 34 is data indicating, for example, the outline dimension of a sheet expressed by the number of longitudinal and lateral dots, and the locations of the character entry columns in the sheet.

The database 16 is a storage part storing the character images 31 and the text data 32 in correspondence to each other, the character images 31 being generated based on the handwriting information when characters are entered on the sheet 4, and the text data 32 being obtained by the character recognition of the character images 31.

A sheet management table 33 is stored in the database 16. The sheet management table 33 is a table in which sheet IDs and the sheet forms 34 are shown in correspondence to each other.

The sheet management table 33 is a table for use in deciding which one of the stored sheet forms 34 should be used for the sheet ID received from the digital pen 2.

The correction processing part 18 displays on the display 19 the questionnaire sheet correction window on which the character image data generated by the character image processing part 13 and the text data as the character recognition results outputted by the character recognition part 14 are displayed so as to be visually comparable.

The correction processing part 18 accepts correction input for the text data being the character recognition result which is displayed in the relevant character input column of the questionnaire sheet correction window displayed on the display 19 and updates the text data 32 in the database 16.

The display 19 displays the questionnaire sheet correction window outputted from the correction processing part 18, and so on, and is realized by, for example, a liquid crystal display (TFTmonitor), a CRT monitor, or the like.

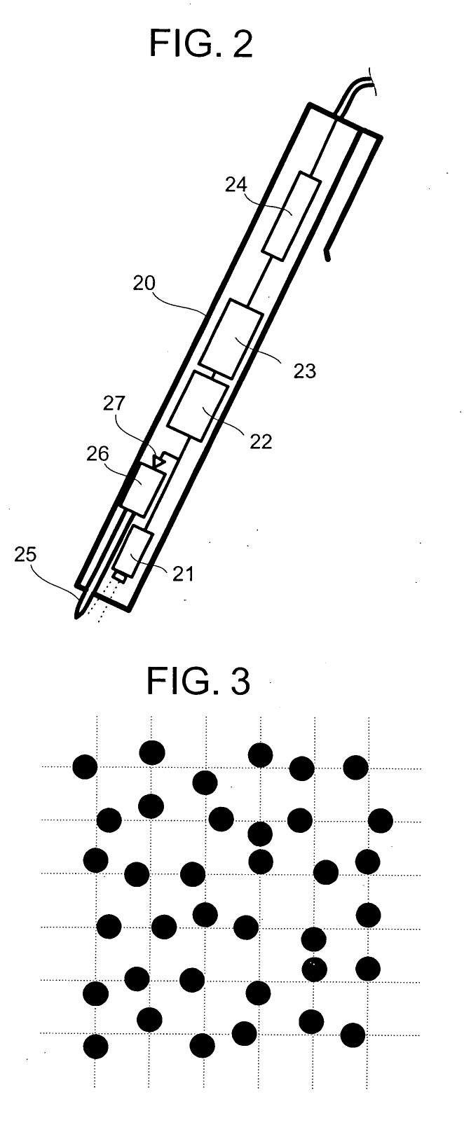

As shown in FIG. 2, the digital pen 2 is composed of a case 20 with a pen-shaped outer appearance, a camera 21 provided in the case 20, a central processing unit 22 (hereinafter, referred to as a CPU 22), a memory 23, a communication part 24, a pen part 25, an ink tank 26, a write pressure sensor 27, and so on.

As the digital pen 2, which is a kind of a digitizer, any other digitizer capable of obtaining the coordinate information and the time information may be used.

An example of the other digitizer is a tablet structured by combining a pen-type device for instructing the position on a screen and a plate-shaped device for detecting the position on the screen designated by a pen tip of this pen-type device.

The camera 21 includes an infrared-emitting part such as a light-emitting diode, a CCD image sensor generating image data on a surface of a sheet, and an optical system such as a lens forming an image on the CCD image sensor.

The infrared-emitting part functions as a lighting part lighting the sheet for image capturing.

The camera 21 has a field of view corresponding to 6×6 dots and takes 50 snapshots or more per second when the write pressure is detected.

When ink supplied from the ink tank 26 seeps out from a tip portion of the pen part 25 and a user brings the tip portion into contact with the surface of the sheet 4, the pen part 25 makes ink adhere on the surface of the sheet 4, thereby capable of writing a character and drawing a figure.

The pen part 25 is of a pressure-sensitive type that contracts/expands in response to the application of the pressure to the tip portion.

When the tip portion of the pen part 25 is pressed (pointed) against the sheet 4, the write pressure sensor 27 detects the write pressure.

A write pressure detection signal indicating the write pressure detected by the write pressure sensor 27 is notified to the CPU 22, so that the CPU 22 starts reading the dot pattern on the sheet surface photographed by the camera 21.

That is, the pen part 25 has a function of a ball-point pen and a write pressure detecting function.

The CPU 22 reads the dot pattern from the sheet 4 at a certain sampling rate to instantaneously recognize an enormous amount of information (the handwriting information including the stroke information such as the trajectory, stroke order, and speed of the pen part 21, the write pressure, the write time, and so on) accompanying a read operation.

When the position of the start mark 41 is pointed, the CPU 22 judges that the reading is started, and when the position of the end mark 42 is pointed, the CPU 22 judges that the reading is ended.

During a period from the start to end of the reading, the CPU 22 performs image processing on the information which is obtained from the camera 21 in response to the write pressure detection, and generates the position information to store the position information together with the time as the handwriting information in the memory 23.

The coordinate information corresponding to the dot pattern printed on the sheet 4 is stored in the memory 23.

In the memory 23, also stored are: the sheet IDs as information for identifying the sheets 4 when the position coordinates of the start mark 41 are read; and pen IDs as information for identifying pens themselves.

The memory 23 holds the handwriting information which is processed by the CPU 22 when the position of the end mark 42 is pointed, until the handwriting information is transmitted to the character reader 1.

The communication part 24 transmits the information in the memory 23 to the character reader 1 via the USB cable 3 connected to the character reader 1.

Besides wired communication using the USB cable 3, wireless communication (IrDA communication, Bluetooth communication, or the like) is another example of a transfer method of the information stored in the memory 23. Bluetooth is a registered trademark.

Power is supplied to the digital pen 2 from the character reader 1 through the USB cable 3.

The digitizer is not limited to the above-described combination of the digital pen 2 and the sheet 4, but may be a digital pen that includes a transmitting part transmitting ultrasound toward a pen tip and a receiving part receiving the ultrasound reflected on a sheet or a tablet and that obtains the trajectory of the movement of the pen tip from the ultrasound. The present invention is not limited to the digital pen 2 in the above-described embodiment.

FIG. 3 is a view showing a range of the sheet 4 imaged by the camera 21 of the digital pen 2.

A range on the sheet 4 readable at one time by the camera 21 mounted in the digital pen 2 is a range of 6×6 dots arranged in matrix, namely, 36 dots in a case where the dots are arranged at about 0.3 mm intervals.

If 36-dot ranges that are longitudinally and laterally deviated are combined and are entirely covered, a sheet consisting of a huge coordinate plane of, for example, about 60,000,000 square meters could be created.

Any 6×6 dots (squares) selected from such a huge coordinate plane are different in dot pattern.

Therefore, by storing the position data (coordinate information) corresponding to the individual dot patterns in the memory 23 in advance, the trajectories of the digital pen 2 on the sheet 4 (on the dot pattern) can all be recognized as different pieces of position information.

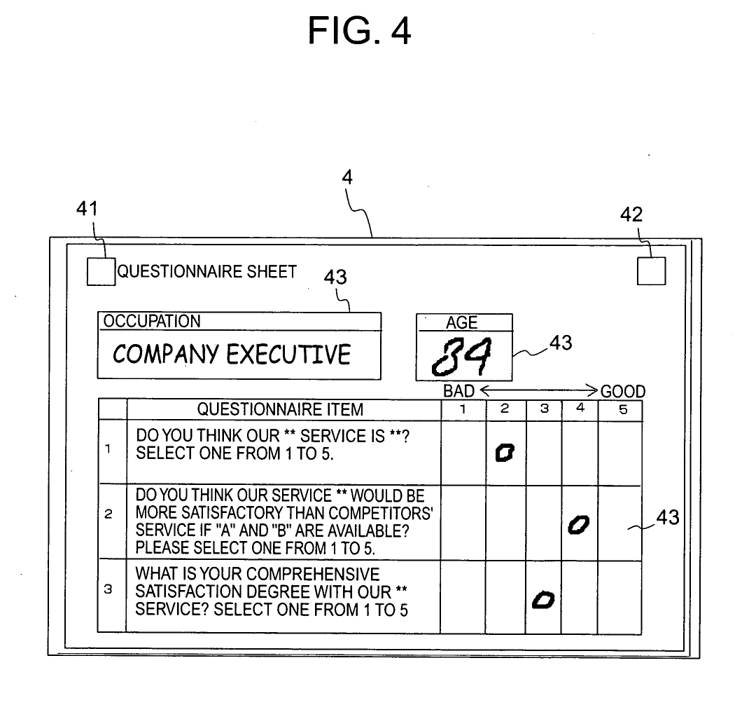

Hereinafter, the operation of the character reading system will be described with reference to FIG. 4 to FIG. 6.

In this character reading system, a designated questionnaire sheet is used.

As shown in, for example, FIG. 4, in addition to the start mark 41 and the end mark 42, the questionnaire sheet as the sheet 4 has the character entry columns 43 such as an occupation entry column, an age entry column, check columns in which relevant places of 1-5 stage evaluation are checked regarding several questionnaire items.

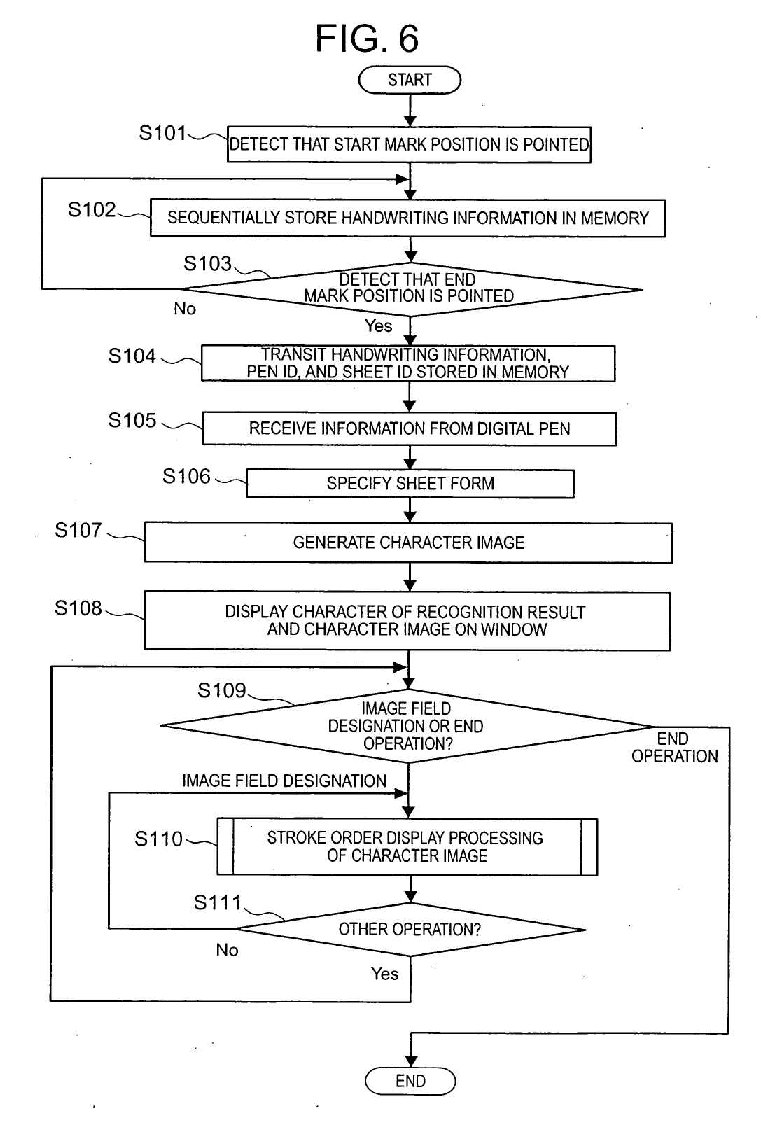

When a questionnaire respondent points the position of the start mark 41 on the questionnaire sheet with the digital pen 2, the write pressure is detected by the write pressure sensor 27, so that the CPU 22 detects that this position is pointed (Step S101 in FIG. 6).

At the same time, the dot pattern in this position is read by the camera 21.

The CPU 22 specifies a corresponding one of the sheet IDs stored in the memory 23 based on the dot pattern read by the camera 21.

When characters are thereafter written (entered) in the character entry columns 43 of the sheet 4, the CPU 22 processes images captured by the camera 21 and sequentially stores, in the memory 23, the handwriting information obtained by the image processing (Step S102).

In the image processing, performed are processing such as analyzing the dot pattern of an image in a predetermined area near the pen tip, which is captured by the camera 21, and converting it to the position information.

The CPU 22 repeats the above-described image processing until it detects that the end mark 42 is pointed (Step S103).

When detecting that the end mark 42 is pointed (Yes at Step S103), the CPU 22 transmits the handwriting information, the pen ID, and the sheet ID which have been stored in the memory 23, to the character reader 1 via the USB cable 3 (Step S104).

The character reader 1 receives, at the communication I/F 11, the information such as the handwriting information, the pen ID, and the sheet ID transmitted from the digital pen 2 (Step S105) to store them in the memory part 12.

The control part 10 refers to the database 16 based on the sheet ID stored in the memory part 12 to specify the sheet form 34 of the sheet 4 on which the characters were handwritten (Step S106).

Next, the character image processing part 13 generates an image of each character, that is, the character image, by using the stroke information included in the handwriting information stored in the memory part 12 (Step S107) to store the character images in the memory part 12 together with the coordinate data (position information).

After the character images are stored, the character recognition part 14 performs character recognition by image matching of the character images read from the memory part 12 and the character images in the dictionary 15 and reads the text data corresponding to identical or similar character images from the dictionary 15 to store the read text data in the memory part 12 as the character recognition results.

Incidentally, in a case where no identical or similar character image is hit in the character recognition processing by the character recognition part 14, “?” which is text data indicating an unrecognizable character is assigned as the character recognition result of this character image.

The correction processing part 18 reads from the memory part 12 the text data, which are the character recognition results by the character recognition part 14, and the character images, and displays them in corresponding fields on the questionnaire sheet correction window (see FIG. 5) (Step S108).

An example of the questionnaire sheet correction window is shown in FIG. 5.

As shown in FIG. 5, the questionnaire sheet correction window has an occupation image field 51, an occupation recognition result field 52, an age image field 53, an age recognition result field 54, an evaluation image field 55, evaluation value recognition result fields 56 for respective questionnaire items, and so on.

In the occupation image field 51, a character image inputted in handwriting in the occupation entry column is displayed.

In the occupation recognition result field 52, the result (text data such as “company executive”) of the character recognition of a character image inputted in handwriting in the occupation entry column is displayed.

In the age image field 53, a character image inputted in handwriting in the age entry column is displayed.

In the age recognition result field 54, the result (text data such as “?9”) of character recognition of a character image inputted in handwriting in the age entry column is displayed.

In the evaluation image field 55, images of the check columns are displayed.

In the evaluation value recognition result fields 56 for the respective questionnaire items, evaluation values (numerals 1-5) that are checked in the check columns regarding the respective items are displayed.

In this example, “2” as the evaluation value of the questionnaire item 1, “4” as the evaluation value of the questionnaire item 2, and “3” as the evaluation value of the questionnaire item 3 are displayed.

The displayed contents of the text data displayed in each of the recognition result fields can be corrected by key input of new text data from the input part 9.

After the correction, the corrected contents (the image data of the recognition source character and the text data as the recognition result) are stored in the database 16 in correspondence to each other by a storage operation.

A work of totaling the results of the questionnaire either includes only a collation work or includes a combined work of a reject correction step and a collation step, depending on character recognition accuracy.

The collation work is a work to mainly confirm the recognition result by displaying the character image and its recognition result, in a case where the character recognition accuracy is relatively high.

The reject correction step in the combined work is a step to correct the text data defined as “?”, in a case where the character recognition rate is low, and is followed by the collation step after the correction.

The aforesaid questionnaire sheet correction window is an example in the collation step, and an operator (correction operator) visually compares the contents (the character images and the recognition results) displayed on the questionnaire sheet correction window to judge the correctness of the recognition results.

When judging that the correction is necessary, the operator corrects the text data in the corresponding field.

Even when the operator (correction operator) refers to the corresponding age image field 53 for an unrecognizable part (rejected part) outputted as “?” in the age recognition result field 54 on the questionnaire sheet correction window displayed on the display 19, the operator sometimes cannot determine whether the numeral corresponding to “?” in the age recognition result field 54 is “3”, or “8” due to the limitation of the window (area, reduced image field display or the like).

Even by referring to the character image in a still state in the age image field 53, it is also sometime difficult to confirm whether the read result numeral “9” displayed in the age recognition result field 54, which corresponds to an adjacent character in the age image field 53, is correct or not.

In such a case, the operator (correction operator) moves the cursor to the character position in the rectangle in the age image field 53 by operating the mouse and double-clicks the mouse.

In response to this double-click operation (image field designation at Step S109) serving as a trigger, the correction processing part 18 performs stroke order display processing of the character image in the relevant image field (Step S110).

The stroke order display processing will be described in detail.

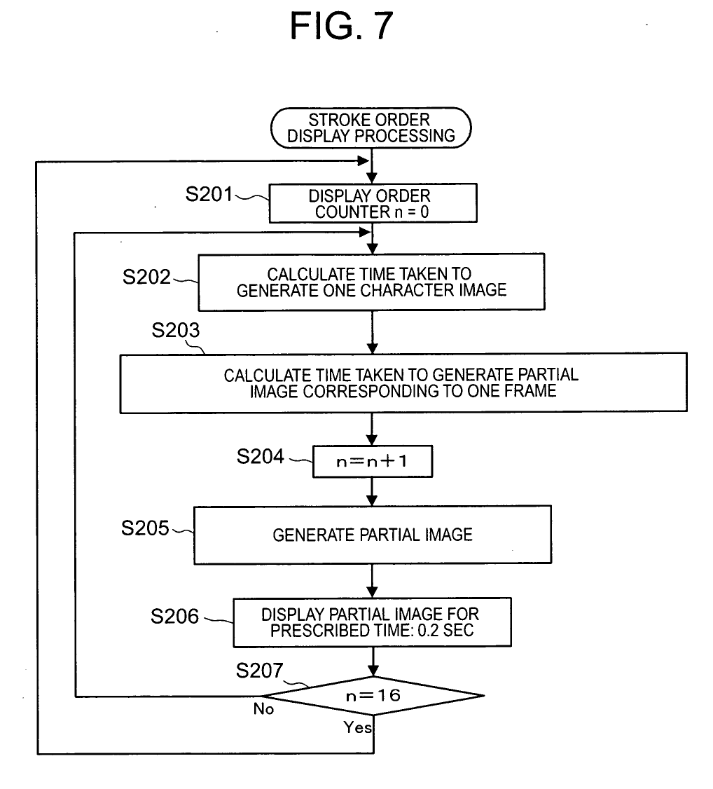

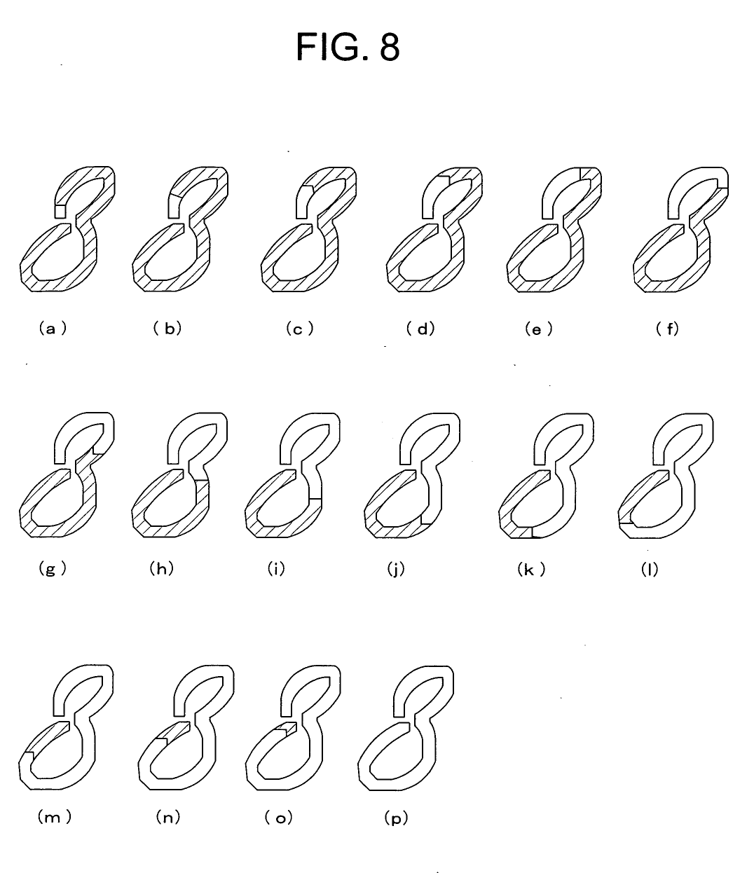

In this case, as shown in FIG. 7, the correction processing part 18 clears a value “n” of a display order counter to zero (Step S201).

Next, the correction processing part 18 reads the handwriting information stored in the memory part 12 to calculate the time taken to generate one character image, by using the handwriting information (Step S202).

The correction processing part 18 divides the calculated time taken to generate one character image by the number of display frames (for example, 16 or the like) of partial images of the character (hereinafter, referred to as partial images) displayed at one time, thereby calculating the time taken to generate the partial image corresponding to one frame (Step S203).

The correction processing part 18 adds “1” to the value “n” of the display order counter (Step S204) and generates the partial image that is drawn by a stroke corresponding to the time which is equal to the generation time of the partial image corresponding to one frame multiplied by “n” (Step S205).

The correction processing part 18 displays the generated partial image in the corresponding image field for a prescribed time defined in advance (for example, 0.2 seconds) (Step S206).

The correction processing part 18 repeats a series of the partial image generation and display operation until the value “n” of the display order counter reaches 16 (Step S207).

Specifically, as shown in FIG. 8(a) to FIG. 8(p), the correction processing part 18 erases the character image displayed in the age image field 53 from this field, and based on the stroke information (the handwriting information of the character) read from the memory part 12, it sequentially displays the partial character images generated in the course until the target image data is completed as one character, in this field at predetermined time intervals.

The predetermined time interval is the time defined (set) in advance, for example, 0.2 seconds or the like, and this time is changeable from a setting change window.

In this manner, the stroke order of the character image when the character is handwritten is reproduced in the age image field 53 as if the character image were being entered thereto, so that the operator (correction operator) seeing this stroke order can determine whether the reproduced stroke order corresponds to the strokes of the numeral “8”, or the strokes of the numeral “3”.

In this example, it can be judged that the stroke order corresponds to the numeral “3”, based on the stroke order from (h) onward in FIG. 8.

Then, when the operator (correction operator) performs, for example, an end operation (an end operation at Step S109) as other operation (Yes at Step S111), a series of the processing is finished.

The operator (correction operator) erases “?” in the age recognition result field 54 and newly key-inputs the numeral “3” by operating the keyboard and the mouse.

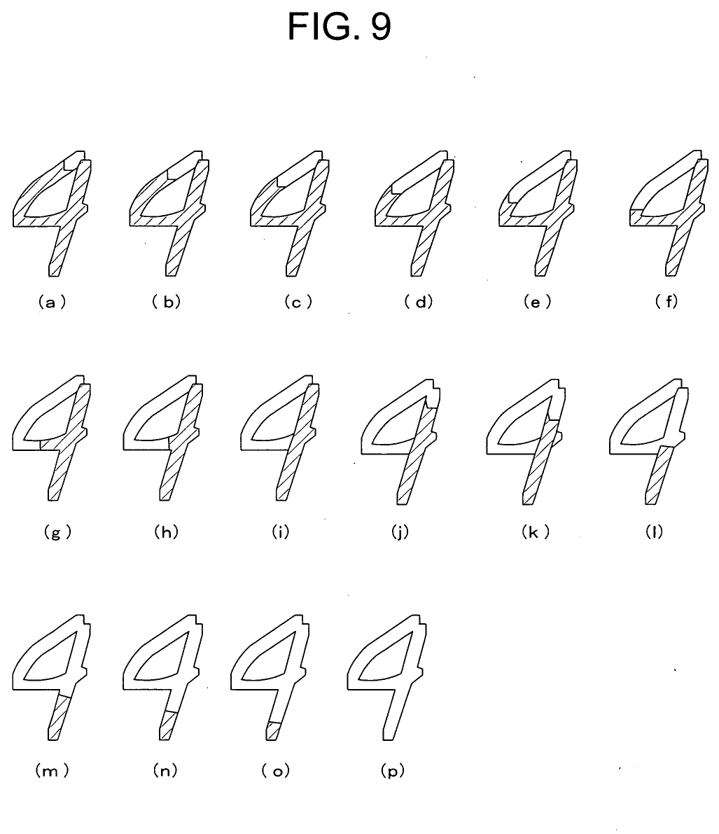

After key-inputting the numeral “3”, the operator (correction operator) moves the cursor to the position of the character image in the age image field 53 by operating the mouse and double-clicks the mouse. Then, in response to the double-click operation serving as a trigger, the correction processing part 18 erases the character image displayed in the age image field 53 from this field, and based on the stroke information (the handwriting information of the character) read from the memory part 12, it sequentially displays the partial character images generated in the course until the target image data is completed as one character, in this field at predetermined time intervals, as shown in FIG. 9(a) to FIG. 9(p)

Consequently, in the age image field 53, the stroke order of the character image when the character was handwritten is reproduced as if the character image were being entered.

Therefore, the operator (correction operator) seeing this stroke order display can determine whether this stroke order corresponds to the strokes of the numeral “4” or the strokes of the numeral “9”. In this example, it can be judged that the stroke order corresponds to the numeral “4”, based on the stroke order in FIG. 9(j) to FIG. 9(k).

The operator (correction operator) erases “9” in the age recognition result field 54 and newly key-inputs the numeral “4” by operating the keyboard and the mouse.

That is, in this example, the occupation of the questionnaire respondent is “company executive”, and the questionnaire information can be corrected such that the age, which was erroneously read in the character recognition based on the handwritten images, is “34”.

The operator (correction operator) performs a determination operation of the numerals “3” and “4” which are inputted as the correction to the age recognition result field 54, and thereafter, the correction processing part 18 stores the determined contents (the text data and the character image) in the database 16 in correspondence to each other.

As described above, according to the character reading system of this embodiment, based on the stroke information included in the handwriting information which is obtained from the digitizer composed of the combination of the pen-type optical input device such as the digital pen 2 and the dot pattern on the sheet 4, the stroke order of any of the characters written in the character entry columns 43 of the sheet 4 is displayed on the questionnaire sheet correction window, so that it is possible to surely determine which character the written character is even when the sheet 4 is not at hand. This enables efficient correction work of recognition result characters.

That is, when there occurs a character whose still image such as the image data is difficult for a person to see or recognize, the time-changing stroke order (time-lapse traces/moving images of the movement course of the pen tip) of the entered character is displayed based on the stroke information on the entered character, thereby making the entered character recognizable or confirmable. This can assist (help) the operator (correction operator) in the data confirmation and data correction of the questionnaire result.

(Other Embodiments)

The present invention is not limited to several embodiments described here with reference to the drawings, but may be expanded and modified. It is understood that expanded and modified inventions within the range of the following claims are all included in the technical scope of the present invention.

The questionnaire sheet correction window in the collation step is taken as an example in the description of the foregoing embodiment, but the stroke order display processing can be executed also on a reject correction window in the reject correction step.

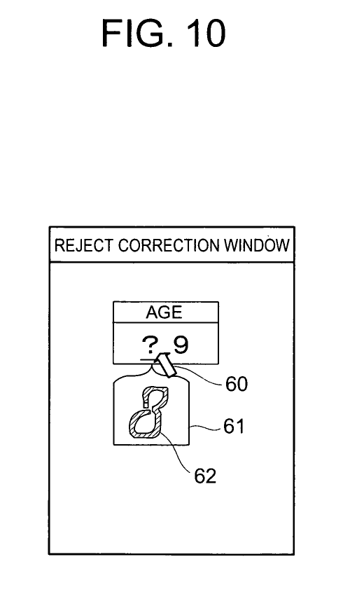

In this case, as shown in FIG. 10, a rejected character is displayed in a corresponding column (an age column in this case) on the reject correction window, and therefore, the operator (correction operator) moves a cursor 60 to the position of this character in the age column, and in response to this movement serving as a trigger, the correction processing part 18 displays a popup window 61 and displays changing partial images 62 in the popup window 61 in the sequence of the stroke order at predetermined time intervals (in a similar manner to the stroke order display examples shown in FIG. 8 and FIG. 9).

Further, the foregoing embodiment has described the stroke order display processing as the operation of the correction processing part 18. However, if the processing to generate the partial images for the stroke order display is executed by the character image processing part 13, a similar processing engine need not be mounted in the correction processing part 18.

That is, the control part 10 controls the correction processing part 18 and the character image processing part 13 to divide the processing between these parts.

In this case, with an operation on the window serving as a trigger, such as a selection operation of a field displaying a character image or a movement operation of the cursor to a display field of a character recognition result, the control part 10 executes the stroke order display processing, where the character image processing part 13 is caused to execute the generation processing of the partial character images, and the correction processing part 18 is caused to sequentially display the generated partial character images on the questionnaire correction window.

Possible display methods of the partial character images are to display the partial character images in place of the original image, to display the partial character images in different color from the original character image and in a superimposed manner on the original image, to display a popup window and display the partial character images on this window, and the like.

Further, in the description of the foregoing embodiment, some field designation operation is executed for triggering the stroke order display processing. Another possible process is to generate character images, without such input (trigger), for example, based on handwriting information when the handwriting information is obtained from the digital pen 2, and then display the stroke order of this character.

What is claimed is:

1. A character reader, comprising:
a handwriting information obtaining part that obtains handwriting information of a character handwritten on a sheet;
a character image generating part that generates partial character images in order in which the character is written, based on the handwriting information of the character obtained by said handwriting information obtaining part; and
a stroke order display part that displays the partial character images generated by said character image generating part, in sequence at predetermined time intervals.

2. A character reader, comprising:
a handwriting information obtaining part that obtains handwriting information of a character handwritten on a sheet;
a display that displays image data of the character, the image data being generated based on the handwriting information of the character obtained by said handwriting information obtaining part; and
a stroke order display part that, in response to an operation for displaying stroke order of the character image data displayed on said display, sequentially displays partial character images on said display based on the handwriting information of the character obtained by said handwriting information obtaining part, the partial character images being images generated in a course until the target image data is completed as one character.

3. The character reader as set forth in claim 1 or claim 2, further comprising:
a character recognition part that outputs text data resulting from character recognition that is performed by using the character image data; and
a correction processing part that displays a window on which the text data outputted from said character recognition part and the image data are displayed so as to be visually comparable for confirmation or correction of the text data which is the character recognition result.

4. The image reader as set forth in claim 1,
wherein said stroke order display part performs stroke order display processing, with one of the following operations serving as a trigger: a selection operation of a display field displaying the partial character image and a movement operation of a cursor to a display field of the character recognition result.

5. The character reader as set forth in claim 3, further comprising:
an input part that accepts input of new text data for correcting the text data displayed on the window; and
a storage part that stores the new text data accepted by said input part and the image data in correspondence to each other.

6. A character reading method for a character reader including a display, the method comprising:
obtaining, by the character reader, handwriting information of a character handwritten on a sheet;
generating, by the character reader, partial character images in order in which the character is written, based on the obtained handwriting information of the character; and
displaying, by the character reader, the generated partial character images on the display in sequence at predetermined time intervals.

7. A character reading program causing a character reader to execute processing, the program comprising program codes for causing the character reader to function as:
a handwriting information obtaining part that obtains handwriting information of a character handwritten on a sheet;
a character image generating part that generates partial character images in order in which the character is written, based on the handwriting information obtained by the handwriting information obtaining part; and
a stroke order display part that displays the partial character images generated by the character image generating part, in sequence at predetermined time intervals.
